(19) United States
(12) Patent Application Publication
(10) Pub. No.: US 2021/0152012 A1
(43) Pub. Date: May 20, 2021

(54) ELECTRONIC APPARATUS AND CHARGING CONTROL METHOD OF ELECTRONIC APPARATUS

(71) Applicant: LG ELECTRONICS INC., Seoul (KR)

(72) Inventors: Minhun HA, Seoul (KR); Buyoung YANG, Seoul (KR); Sanghoon KIM, Seoul (KR); Youngtae KIM, Seoul (KR); Hyeongseog KIM, Seoul (KR)

(73) Assignee: LG ELECTRONICS INC., Seoul (KR)

(21) Appl. No.: 16/784,681

(22) Filed: Feb. 7, 2020

(30) Foreign Application Priority Data
Nov. 19, 2019 (KR) PCT/KR2019/015861

(51) Int. Cl. H02J 7/00

(52) U.S. Cl. CPC H02J 7/007194; H02J 7/0048

(57) ABSTRACT

An electronic apparatus including a battery; and a controller configured to acquire use information of the battery, variably set a threshold range between a first threshold and a second threshold based on the acquired use information, and charge the battery when a sensed temperature of the battery is greater than or equal to the first threshold and less than or equal to the second threshold.

### CROSS-REFERENCE TO RELATED APPLICATION

Pursuant to 35 U.S.C. § 119(a), this application claims the benefit of earlier filing date and right of priority to PCT International Application No. PCT/KR2019/015861 filed on Nov. 19, 2019, the contents of which are hereby incorporated by reference herein in its entirety.

### BACKGROUND OF THE INVENTION

### 1. Field of the Invention

This disclosure relates to an electronic apparatus.

### 2. Discussion of the Related Art

Recently, with developments of digital technologies, various types of electronic devices such as a mobile communication terminal, a smartphone, a tablet personal computer (PC), a notebook, a personal digital assistant (PDA), a wearable device, or a digital camera are widely used. As more functions are provided by such electronic devices, interest in technology for charging a battery for supplying power to an electronic apparatus has increased.

### SUMMARY OF THE INVENTION

In an electronic apparatus, repetitive charging and discharging of a battery may cause a degradation in battery performance or a swelling phenomenon of a battery pack. In particular, the swelling phenomenon may cause an occurrence of a safety accident such as fire or explosion. Thus, safety measures may be required.

An aspect provides an electronic apparatus and a method to efficiently control charging of a battery based on a state of use (or a degree of use) of the battery.

According to an aspect, there is provided an electronic apparatus including a battery and a controller, wherein the controller is configured to acquire use information of the battery and determine a charging condition of the battery based on the use information of the battery.

According to another aspect, there is also provided an electronic apparatus including a battery, at least one sensor, and a controller, wherein the controller is configured to acquire use information of the battery and temperature information of the battery using the at least one sensor, determine a charging condition of the battery based on the use information of the battery, and charge the battery in accordance with the charging condition of the battery based on the temperature information of the battery.

### BRIEF DESCRIPTION OF THE DRAWINGS

The above and other aspects, features, and advantages of certain embodiments will be more apparent from the following detailed description taken in conjunction with the accompanying drawings, in which:

FIG. 1 is a block diagram illustrating an electronic apparatus according to various embodiments of the present disclosure;

FIG. 2 is a block diagram illustrating a charging control method of an electronic apparatus according to an example embodiment of the present disclosure;

FIG. 3 is a flowchart illustrating a charging control method of an electronic apparatus according to an example embodiment of the present disclosure;

FIG. 4 is a flowchart illustrating a charging control method of an electronic apparatus according to an example embodiment of the present disclosure; and

FIG. 5 is a flowchart illustrating a charging control method of an electronic apparatus according to an example embodiment of the present disclosure.

### DETAILED DESCRIPTION OF THE EMBODIMENTS

Hereinafter, preferred embodiments of the present disclosure will be described in detail with reference to the accompanying drawings, and the same or similar elements are designated with the same numeral references regardless of the numerals in the drawings and their redundant description will be omitted. A suffix “module” or “unit” used for constituent elements disclosed in the following description is merely intended for easy description of the specification, and the suffix itself does not give any special meaning or function. Also, it should be noted that the accompanying drawings are merely illustrated to easily explain the concept of the invention, and therefore, they should not be construed to limit the technological concept disclosed herein by the accompanying drawings.

The terms ‘first’, ‘second’, etc. may be used to describe various components, but the components are not limited by such terms. The terms are used only for the purpose of distinguishing one component from other components.

When an arbitrary component is described as “being connected to” or “being linked to” another component, this should be understood to mean that still another component(s) may exist between them, although the arbitrary component may be directly connected to, or linked to, the corresponding other component. In contrast, when an arbitrary component is described as “being directly connected to” or “being directly linked to” another component, this should be understood to mean that no component exists between them.

A singular expression can include a plural expression as long as it does not have an apparently different meaning in context. In the present application, the terms “include” and “have” should be understood to be intended to designate that illustrated features, numbers, steps, operations, components, parts or combinations thereof exist and not to preclude the existence of one or more different features, numbers, steps, operations, components, parts or combinations thereof, or the possibility of the addition thereof.

An electronic device according to various embodiments may include at least one of a mobile phone, a smartphone, a laptop computer, a digital broadcasting terminal, personal digital assistants (PDA), a portable multimedia player (PMP), a navigator, a slate PC, a tablet PC, an ultrabook, a wearable device (e.g., smartwatch), a smart glass, a head-mounted display (HMD), a digital TV, a desktop computer, or a digital signage.

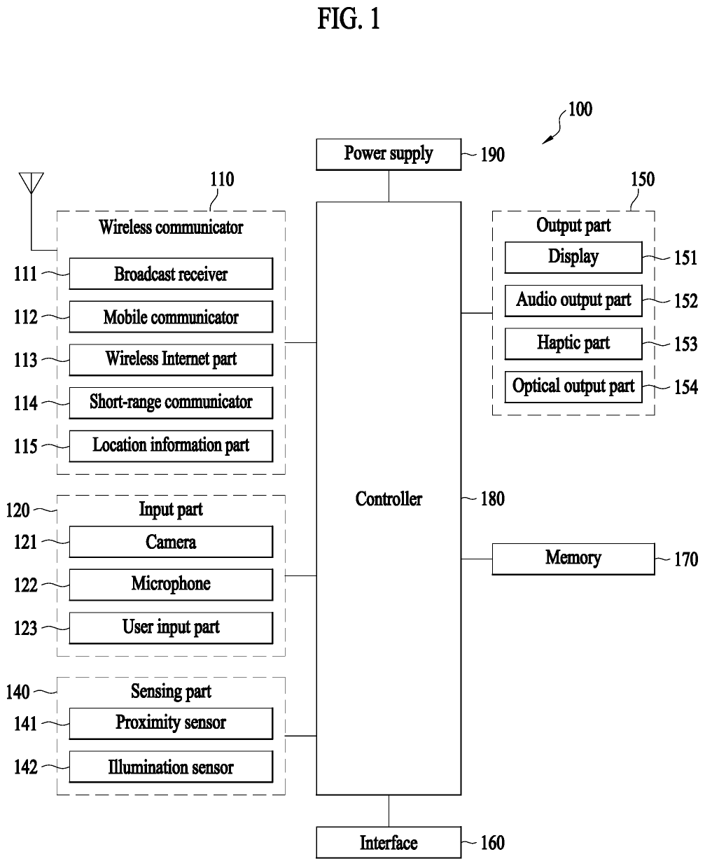

FIG. 1 is a block diagram illustrating an electronic apparatus according to various embodiments. Referring to FIG. 1, an electronic apparatus 100 includes at least one of a wireless communicator 110, an input part 120, a sensing part 140, an output part 150, an interface 160, a memory 170, a controller (or processor) 180, and a power supply 190. The electronic apparatus 100 may include other components in addition to the components of FIG. 1 and may also include some of the components of FIG. 1.

The wireless communicator 110 may include at least one module that enables wireless communication to be performed between the electronic apparatus 100 and a wireless communication system, between the electronic apparatus 100 and another electronic apparatus (e.g., the electronic apparatus 100), or between the electronic apparatus 100 and an external server. The wireless communicator 110 may include one or more modules that connect the electronic apparatus 100 to one or more networks. The wireless communicator 110 may include at least one of a broadcast receiver 111, a mobile communicator 112, a wireless internet part 113, a short-range communicator (NFC) 114, and a location information part 115.

The input part 120 may include at least one of an image input part (for example, a camera 121) that receives an image signal input, an audio input part (for example, a microphone 122) that receives an audio signal input, or a user input part 123 that receives a user input. For example, the user input part 123 can receive a user touch input through a touch sensor (or touch panel) provided in a display 151 or receive a user input through a mechanical key. Information collected in the input part 120 (for example, voice data and image data) can be analyzed and processed as a control command of a user.

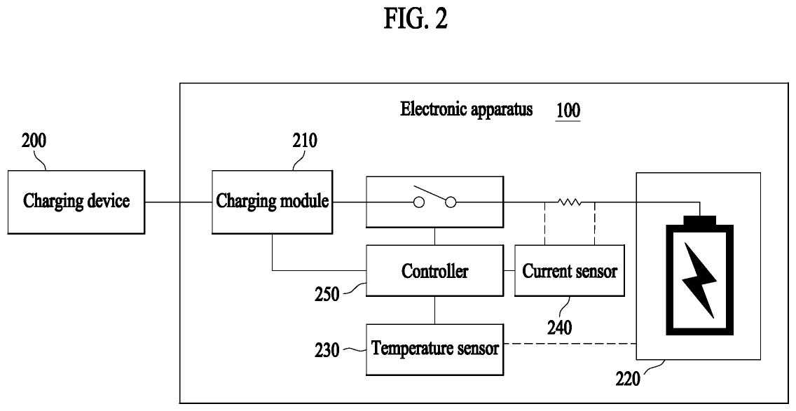

The sensing part 140 may include one or more sensors to sense at least one of information in the electronic apparatus 100, surrounding environment information of the electronic apparatus 100, or user information. For example, the sensing part 140 may include at least one of a proximity sensor 141, an illumination sensor 142, a touch sensor, or a finger scan sensor. In addition, the sensing part 140 may include at least one of an acceleration sensor, a magnetic sensor, a gravity (G)-sensor, a gyroscope sensor, a motion sensor, an RGB sensor, an infrared (IR) sensor, an ultrasonic sensor, an optical sensor, a battery gauge (for example, a temperature sensor 230, a current sensor 240 in FIG. 2), an environment sensor (for example, a barometer, a hygrometer, a thermometer, a radioactivity sensor, a heat sensor, and a gas detection sensor), or a chemical sensor (for example, an electronic nose, a healthcare sensor, and a biometric sensor). In the present disclosure, the electronic apparatus 100 may use a combination of pieces of information sensed in at least two sensors among the aforementioned sensors.

The output part 150 can output information related to visual, auditory, or tactile. For example, the output part 150 may include at least one of the display 151, an audio output part 152, a haptic part 153, or an optical output part 154. In one embodiment, the display 151 may form a layer structure or an integrated structure with a touch sensor to implement a touch screen that simultaneously provides a touch input function and a screen output function. For example, the touch screen can function as the user input part 123 that provides an input interface between the electronic apparatus 100 and a user and can function as the output part 150 that provides an output interface between the electronic apparatus 100 and the user.

The audio output part 152 can externally output audio data stored in the memory 170 or received from the wireless communicator 110 in a call signal reception, a call mode or a recording mode, a voice recognition mode, a broadcast reception mode, or the like. The audio output part 152 can output an acoustic signal associated with a function (for example, a call signal reception sound and a message reception sound) performed in the electronic apparatus 100. For example, the audio output part 152 may include at least one of a receiver, a speaker, or a buzzer.

The memory 170 can store data related to various functions of the electronic apparatus 100. For example, the memory 170 can store application programs (or applications) run in the electronic apparatus 100, data for operation of the electronic apparatus 100, and instructions. As an example, at least a portion of the application programs can be downloaded from an external server through wireless communication. As another example, at least a portion of the application programs can be previously stored in the memory 170 for a function (for example, call forwarding and outgoing function and message receiving and outgoing function) of the electronic apparatus 100. The application program stored in the memory 170 can be run to perform a predetermined operation (or function) of the electronic apparatus 100 based on the controller 180.

The controller 180 (e.g., processor) can control an overall operation of the electronic apparatus 100. For example, the controller 180 can process a signal, data, information, and the like input or output through components of the electronic apparatus 100 or run the application program stored in the memory 170, thereby providing information to a user or performing a predetermined function.

For example, to run the application program stored in the memory 170, the controller 180 can control at least a portion of the components of the electronic apparatus 100 of FIG. 1. To run the application program, the controller 180 can operate a combination of two or more components among the components included in the electronic apparatus 100.

The power supply 190 can supply power to each component included in the electronic apparatus 100 by receiving external or internal power based on a control of the controller 180. The power supply 190 may include a battery. The battery may include a built-in battery or a removable battery. For example, the power supply 190 can receive power from a battery (e.g., a battery 220 of FIG. 2). The battery may include a built-in battery or a removable battery.

The power supply 190 may include a power regulator that adjusts a voltage level or current level of the power. The power supply 190 can adjust the power to a voltage level or current level suitable for each component of the electronic apparatus 100 and provide the adjusted power to the corresponding component.

At least some of the above-described components of the electronic apparatus 100 can cooperate with one another to implement an operation, a control, or a control method of the electronic apparatus 100 described herein. Also, the operation, the control, or the control method of the electronic apparatus 100 can be implemented through an execution of at least one application program stored in the memory 170.

Next, FIG. 2 is a block diagram illustrating a charging control method of an electronic apparatus according to an example embodiment of the present disclosure. Referring to FIG. 2, the electronic apparatus 100 according to various embodiments includes a charging module 210 and a battery 220.

The charging module 210 charges the battery 220 using power supplied from an external charging device 200. In more detail, the charging module 210 can select a charging scheme based on at least one of a type of the charging device 200, an amount of power to be supplied from the charging device 200, or a state of the battery 220 (for example, a state of use of the battery 220, a temperature of the battery 220, and a magnitude of charging current). The charging module 210 can then charge the battery 220 based on the selected charging scheme. The selecting of the charging scheme can be performed under a control of a controller 250, for example.

For example, the charging module 210 can control a charging voltage or a charging current to charge the battery 220 through either a fast charging or a normal speed charging. Also, the charging module 210 can charge the battery 220 through either a wired charging or a wireless charging based on a type of the charging device 200.

Further, the charging module 210 may include at least one of a wired charging module or a wireless charging module. As an example, the electronic apparatus 100 can be connected to the charging device 200 through a connecting port provided as an interface (e.g., the interface 160 of FIG. 1). The charging module 210 can charge the battery 220 using power supplied from the charging device 200 to which the charging module 210 is wired through the connecting port. As another example, the charging module 210 can wirelessly charge the battery 220 without using the connecting port. When the external charging device 200 is determined as a wireless power transmitting device, the electronic apparatus 100 can be supplied with power using at least one of an inductive coupling scheme based on a magnetic induction phenomenon or a magnetic resonance coupling scheme based on an electromagnetic resonance phenomenon, to charge the battery 220.

The electronic apparatus 100 may also include at least one sensor, for example, a battery gauge to acquire state information of the battery 220. For example, the electronic apparatus 100 can use a temperature sensor 230 and a current sensor 240 to acquire temperature information of the battery 220 and information on a current supplied to the battery 220. Further, the electronic apparatus 100 can use the at least one sensor to acquire state information associated with at least one of a capacitance of the battery 220, a number of charging and discharging times, overcharging, over-discharging, cell-balancing, or whether swelling occurs.

In addition, the controller 250 (e.g., the controller 180 of FIG. 1) can acquire at least one of state information or use information of the battery 220 by controlling the at least one sensor. Also, the controller 250 can control the charging module 210 to charge the battery 220 based on a designated charging condition.

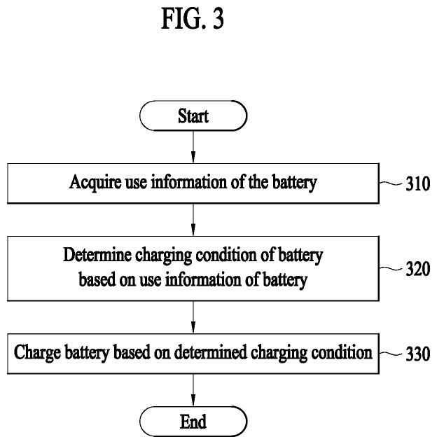

Next, FIG. 3 is a flowchart illustrating a charging control method of an electronic apparatus according to an example embodiment of the present disclosure. Referring to FIG. 3, in operation 310, an electronic apparatus (e.g., the electronic apparatus 100 of FIGS. 1 and 2) according to various embodiments can acquire use information of the battery 220. For example, the use information of the battery 220 includes information associated with a state of use of the battery 220. The use information may include at least one of information associated with a number of charging and discharging times of the battery 220 or information associated with a capacitance of the battery 220. For example, the controller 250 can acquire the use information of the battery 220 using at least one sensor.

In operation 320, the electronic apparatus 100 (e.g., the controller 250 of the electronic apparatus 100) can determine a charging condition related to charging of the battery 220 based on the use information of the battery 220. For example, the charging condition may include at least one of a condition related to whether the battery 220 is to be charged based on a temperature or a condition related to a magnitude of a charging current (and/or charging condition) of the battery 220.

Based on the use information (e.g., use state information) of the battery 220, the controller 250 can set a threshold temperature to allow the charging of the battery 220 or determine a magnitude of a charging current (and/or charging voltage) at a predetermined temperature of the battery 220.

In operation 330, the electronic apparatus 100 (e.g., the controller 250) can charge the battery 220 based on the charging condition determined in operation 320. For example, the controller 250 can control the charging module 210 such that the battery 220 is charged based on the determined charging condition.

Under the control of the controller 250, the charging module 210 can adjust the power supplied from the external charging device 200 to a predetermined current level or voltage level and charge the battery 220 at the adjusted current level or voltage level. Also, the charging module 210 can restrict the charging of the battery 220 based on the charging condition (e.g., a temperature condition of the battery 220) determined by the controller 250.

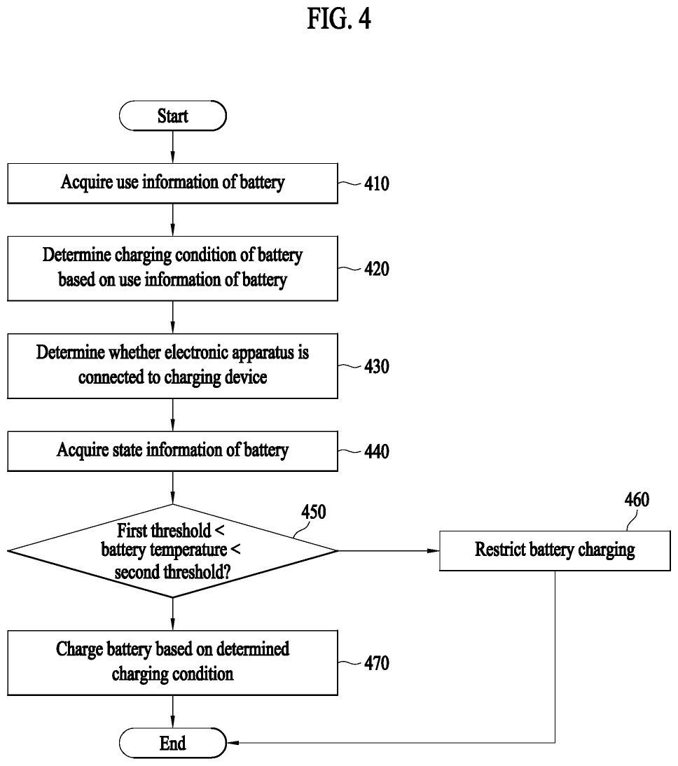

Next, FIG. 4 is a flowchart illustrating a charging control method of an electronic apparatus according to an example embodiment of the present disclosure. Referring to FIG. 4, an electronic apparatus (e.g., the electronic apparatus 100 of FIGS. 1 and 2) according to various embodiments can acquire use information of the battery 220 in operation 410 (e.g., operation 310 of FIG. 3). For example, under a control of the controller 250, the electronic apparatus 100 can acquire at least one of information associated with a number of charging and discharging times or information associated with a capacitance of the battery 220, as information related to a state of use of the battery 220.

Subsequently, in operation 420 (e.g., operation 320 of FIG. 3), the electronic apparatus 100 (e.g., the controller 250) can determine a charging condition of the battery 220 based on the use information of the battery 220 acquired in operation 410. The controller 250 can also determine a charging condition of the battery 220 in association with a temperature of the battery 220 based on the use information of the battery 220. For example, when the battery 220 is at a predetermined temperature, the controller 250 can determine whether to charge the battery 220 based on the use information of the battery 220.

Also, when it is determined that the battery is to be charged at the predetermined temperature, the controller 250 can determine a magnitude of a charging current (or charging voltage) at which the battery 220 is to be charged, based on the use information of the battery 220.

According to an additional embodiment, the electronic apparatus 100 (e.g., the controller 250) can determine a condition of a charging termination time of the battery 220 (for example, a condition of a magnitude of an end of charge (EoC) current of the battery 220) based on the use information. For example, as the battery 220 is repetitively charged and discharged, a performance such as a capacitance of the battery 220 may be deteriorated. In particular, when the battery 220 is forcedly charged under a low or high temperature condition, a degradation in performance of the battery 220 can be accelerated.

The electronic apparatus 100 according to various embodiments of the present disclosure provides an optimized charging scheme suitable for a state of use of the battery 220 by determining a charging condition (e.g., a magnitude of charging current) of the battery 220 based on the use information of the battery 220 or temperature information of the battery 220 such that the battery 220 is more efficiently used.

In operation 430, the electronic apparatus 100 (e.g., the controller 250) can determine whether the electronic apparatus 100 is connected to an external charging device (e.g., the external charging device 200 of FIG. 2). When it is determined that the electronic apparatus 100 is connected with the charging device 200, the electronic apparatus 100 can charge the battery 220 using power provided from the charging device 200. For this, the electronic apparatus 100 (e.g., the controller 250) can identify a type of the charging device 200 and determine a charging scheme (for example, wireless charging, wired charging, normal-speed charging, or fast charging) of the battery 220 based on the type of the charging device 200.

In operation 440, when it is determined that the electronic apparatus 100 is connected with the charging device 200, the electronic apparatus 100 (e.g., the controller 250) can acquire state information of the battery 220. For example, the state information of the electronic apparatus 100 may include temperature information of the battery 220.

In operation 450, the electronic apparatus 100 (e.g., the controller 250) can determine whether a temperature of the battery 220 is within a designated range based on the acquired state information of the battery 220. When the temperature of the battery 220 is less than or equal to a first threshold, or is greater than a second threshold, the electronic apparatus 100 (e.g., the controller 250) can restrict the charging of the battery 220 in operation 460. When the temperature of the battery 220 is greater than the first threshold, and less than the second threshold, in operation 470, the electronic apparatus 100 (e.g., the controller 250) can charge the battery 220 based on the charging condition determined in operation 420.

At least one of the first threshold or the second threshold can be determined in operation 420 based on the use information of the battery 220. In other words, the first threshold and/or the second threshold can be a value varying based on the use information of the battery 220.

According to various embodiments, the controller 250 can set the first threshold to be increased as the number of charging and discharging times of the battery 220 increases or as the capacitance of the battery 220 is reduced. Also, the controller 250 can set the second threshold to be reduced as the number of charging and discharging times of the battery 220 increases or as the capacitance of the battery 220 is reduced.

For example, when the number of charging and discharging times of the battery 220 is less than a designated number of times (or, when the capacitance of the battery 220 is greater than or equal to a designated capacitance), the controller 250 can set the first threshold to be 0° C. and set the second threshold to be 55° C. When the number of charging and discharging times of the battery 220 is greater than or equal to the designated number of times (or when the capacitance of the battery 220 is less than the designated capacitance), the controller 250 can set the first threshold to be 1° C. and set the second threshold to be 54° C. In addition, the controller 250 can set the first threshold to be gradually increased and set the second threshold to be gradually reduced as the number of charging and discharging times of the battery 220 increases (or, as the capacitance of the battery 220 is reduced).

In one embodiment, in operation 460, the electronic apparatus 100 (e.g., the controller 250) can execute a predetermined function when the charging of the battery 220 is restricted. When it is determined that the temperature of the battery 220 is less than or equal to the first threshold, the electronic apparatus 100 can execute a function to increase the temperature of the battery 220. For example, instead of charging the battery 220 with the power supplied from the external charging device 200, the electronic apparatus 100 can apply power to a component (e.g., one of a printed circuit board (PCB), a resistor, or a wireless charging antenna) disposed adjacent to the battery 220 such that the temperature of the battery 220 increases.

In operation 470, the electronic apparatus 100 (e.g., the controller 250) can charge the battery 220 based on a designated charging condition. For example, the controller 250 can control a charging module (e.g., the charging module 210 of FIG. 2) to charge the battery 220 based on the charging condition. The charging condition may include a magnitude of charging current associated with the temperature of the battery 220. For example, in operation 420, the electronic apparatus 100 (e.g., the controller 250) can determine a temperature reference of the battery 220 such as the first threshold and the second temperature, and determine a magnitude reference of the charging current of the battery 220 for each temperature reference.

In addition, the electronic apparatus 100 can set the magnitude of charging current for charging the battery 220 to be reduced as a use amount of the battery 220 increases. When the number of charging and discharging times of the battery 220 is less than the designated number of times (or, in a case in which the capacitance of the battery 220 is greater than or equal to the designated capacitance), the electronic apparatus 100 can control the battery 220 to be charged at a magnitude of a first current when the temperature of the battery 220 is greater than or equal to the first threshold and is less than or equal to the second threshold.

When the number of charging and discharging times of the battery 220 is greater than or equal to the designated number of times (or, in a case in which the capacitance of the battery 220 is less than the designated capacitance), the electronic apparatus 100 can control the battery 220 to be charged at a magnitude of a second current less than that of the first current. The electronic apparatus 100 can control the battery 220 to be charged at a magnitude of a charging current reduced as the number of charging and discharging times of the battery 220 increases (or, as the capacitance of the battery 220 is reduced).

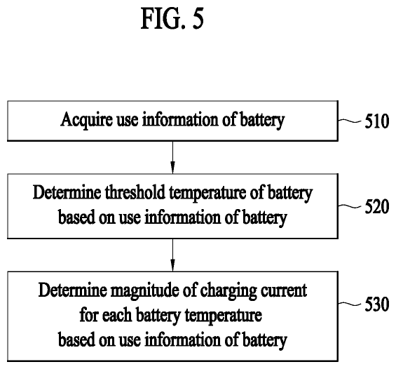

Next, FIG. 5 is a flowchart illustrating a charging control method of an electronic apparatus according to an example embodiment of the present disclosure. In more detail, FIG. 5 is a flowchart illustrating operation 320 of FIG. 3 or operation 420 of FIG. 4 in detail.

In operation 510, the electronic apparatus 100 (e.g., the controller 250) can acquire the use information of the battery 220 using the at least one sensor. Since the description of operation 310 of FIG. 3 or operation 410 of FIG. 4 is applicable here, a repeated description of operation 510 is omitted.

In operation 520, the electronic apparatus 100 can determine a threshold temperature of the battery 220 based on the use information of the battery 220. For example, the electronic apparatus 100 can determine a first threshold and a second threshold based on the use information of the battery 220. The first threshold can be a minimum threshold temperature at which the battery 220 is allowed to be charged, and the second threshold can be a maximum threshold temperature at which the battery 220 is allowed to be charged. The first threshold can increase as a use amount of the battery 220 increases, and the second threshold can be reduced as the use amount of the battery 220 increases.

The electronic apparatus 100 may further include a third threshold and a fourth threshold determined irrespective of the use information of the battery 220. Each of the third threshold and the fourth threshold can be greater than the first threshold and less than the second threshold. Also, the third threshold can be less than the fourth threshold. In other words, the electronic apparatus 100 can have threshold temperatures of which values increase in an ascending order of the first threshold, the third threshold, the fourth threshold, and the second threshold.

According to another embodiment, the third threshold can have a relatively larger value as the use amount of the battery 220 increases. Also, the fourth threshold can have a relatively smaller value as the use amount of the battery 220 increases.

In operation 530, the electronic apparatus 100 can determine a magnitude of charging current for each temperature of the battery 220 based on the use information of the battery 220. The electronic apparatus 100 can determine whether to charge the battery 220 based on each of the threshold temperature values determined in operation 520, or set the magnitude of charging current for each temperature such that the battery 220 is charged at different magnitudes of charging current. For example, the electronic apparatus 100 can acquire temperature information of the battery 220 using at least one sensor and compare the temperature of the battery 220 to the threshold temperature value, thereby determining whether to charge the battery 220 or determining a magnitude of current in charging.

When the temperature of the battery 220 is less than or equal to the first threshold, or is greater than or equal to the second threshold, the electronic apparatus 100 can restrict the charging of the battery 220 such that the battery 220 is not charged. When the temperature of the battery 220 is greater than the first threshold, or is less than or equal to the third threshold, the electronic apparatus 100 can charge the battery 220 at a magnitude of I1. When the temperature of the battery 220 is greater than the third threshold, and is less than or equal to the fourth threshold, the electronic apparatus 100 can charge the battery 220 at a magnitude of I2 greater than I1. When the temperature of the battery 220 is greater than the fourth threshold and less than the second threshold, the electronic apparatus 100 can charge the battery 220 at a magnitude of I3 less than I2. For example, I3 may have a value greater than I1, have a value less than I1, or have a value equal to I1.

In addition, the electronic apparatus 100 can differently determine at least one of the magnitudes of I1, I2, and I3 based on the use information of the battery 220, for example, at least one of the number of charging and discharging times of the battery 220 or the capacitance of the battery 220. For example, the electronic apparatus 100 can differently set the magnitudes of I1 and I3 when the number of charging and discharging times of the battery 220 is less than a predetermined number of times (or the capacitance of the battery 220 is greater than or equal to a predetermined capacitance), and when the number of charging and discharging times of the battery 220 is greater than or equal to the predetermined number of times (or the capacitance of the battery 220 is less than the predetermined capacitance).

According to the repetitive charging and discharging of the battery 220, the electronic apparatus 100 can set the magnitudes of I1 and I3 to be gradually reduced as the number of charging and discharging times of the battery 220 increases or as the capacitance of the battery 220 is reduced. In contrast, the electronic apparatus 100 can set the magnitude of I2 to be constant irrespective of the number of charging and discharging times of the battery 220 or the capacitance of the battery 220.

Considering that a limit temperature and a limit current magnitude to be accepted by the battery 220 vary based on a degree of use of the battery 220, the electronic apparatus 100 according to various embodiments can charge the battery 220 in accordance with a charging condition of the battery 220 optimized based on the degree of use of the battery 220, thereby minimizing a load of the battery 220.

According to embodiments, an electronic apparatus can prepare a charging method optimized based on a state of use (or degree of use) of a battery, thereby minimizing a load of the battery, preventing a damage of a battery cell, and maximizing a battery life of the electronic apparatus. Also, it is possible to minimize an occurrence of a battery swelling phenomenon, thereby improving a stability and a reliability of an electronic apparatus and providing an efficient battery charging function.

Although exemplary embodiments of the present disclosure have been described for illustrative purposes, those skilled in the art will appreciate that various modifications, additions, and substitutions are possible, without departing from the essential characteristics of the disclosure. Therefore, exemplary embodiments of the present disclosure have been described for the sake of brevity and clarity. Accordingly, those skilled in the art will understand the scope of the disclosure is not limited by the explicitly described above embodiments but by the claims and equivalents thereof.

What is claimed is:

1. An electronic apparatus comprising:
a battery; and
a controller configured to:
acquire use information of the battery; and
determine a charging condition of the battery based on the use information of the battery.

2. The electronic apparatus of claim 1, wherein the controller is configured to:
variably set a threshold range between a first threshold and a second threshold based on the use information of the battery;
sense a temperature of the battery; and
charge the battery when the sensed temperature of the battery is greater than or equal to the first threshold and less than or equal to the second threshold.

3. The electronic apparatus of claim 1, wherein the use information of the battery includes information associated with a number of charging and discharging times of the battery.

4. The electronic apparatus of claim 1, wherein the use information of the battery includes information associated with a capacitance of the battery.

5. The electronic apparatus of claim 1, wherein the controller is configured to determine a charging condition of the battery in association with a temperature of the battery based on the use information of the battery.

6. The electronic apparatus of claim 5, further comprising a charging module configured to charge the battery,
wherein the controller is configured to control the charging module to charge the battery based on the determined charging condition of the battery in association with the temperature of the battery.

7. The electronic apparatus of claim 5, wherein the controller is configured to set a magnitude of charging current of the battery in association with the temperature of the battery based on the use information of the battery.

8. The electronic apparatus of claim 7, wherein the controller is configured to reduce the magnitude of the charging current of the battery as a use amount of the battery increases.

9. The electronic apparatus of claim 2, further comprising at least one sensor configured to sense the temperature of the battery,
wherein the controller is configured to set the magnitude of charging current of the battery based on the sensed temperature and the use information of the battery.

10. The electronic apparatus of claim 9, wherein the controller is configured to:
not charge the battery when the sensed temperature of the battery is less than or equal to the first threshold, or greater than or equal to the second threshold; and
control the battery to be charged at the set magnitude of charging current when the temperature of the battery is greater than the first threshold and less than the second threshold.

11. The electronic apparatus of claim 9, wherein the controller is configured to set at least one of the first threshold or the second threshold based on the use information of the battery.

12. The electronic apparatus of claim 11, wherein the controller is configured to increase the first threshold and decrease the second threshold as a use amount of the battery increases, based on the use information of the battery.

13. The electronic apparatus of claim 2, wherein the controller is further configured to:
not charge the battery when the sensed temperature of the battery is less than the first threshold or greater than the second threshold, and
charge the battery using a current determined based on the use information and the temperature of the battery, when the sensed temperature of the battery is greater than or equal to the first threshold and less than or equal to the second threshold.

14. The electronic apparatus of claim 2, wherein the controller is further configured to:
increase the first threshold and decrease the second threshold to reduce the threshold range based on the use information indicating an increased use of the battery.

15. The electronic apparatus of claim 1, wherein the first threshold and the second threshold are temperatures.

16. An electronic apparatus comprising:
a battery;
at least one sensor; and
a controller configured to:
acquire use information of the battery and temperature information of the battery using the at least one sensor,
determine a charging condition of the battery based on the use information of the battery, and
charge the battery based on the determined charging condition of the battery and the acquired temperature information of the battery.

17. The electronic apparatus of claim 16, wherein the charging condition of the battery includes a magnitude of charging current of the battery in association with a temperature of the battery.

18. The electronic apparatus of claim 17, wherein the controller is configured to reduce the magnitude of charging current of the battery when the use information indicates a greater use amount of the battery.

19. The electronic apparatus of claim 17, wherein the controller is configured to increase the magnitude of charging current of the battery when the use information indicates a lesser use amount of the battery.

20. The electronic apparatus of claim 16, wherein the use information of the battery includes at least one of information associated with a number of charging and discharging times of the battery or information associated with a capacitance of the battery.
